(19) United States
(12) Patent Application Publication
(10) Pub. No.: US 2008/0270274 A1
(43) Pub. Date: Oct. 30, 2008

(54) Method, system and apparatus for accounting in network

(75) Inventors: Junxian Mo, Shenzhen (CN); Weimin Chen, Shenzhen (CN); Jiaxing Xiao, Shenzhen (CN)

Correspondence Address: HARNESS, DICKEY & PIERCE, P.L.C., P.O. BOX 828, BLOOMFIELD HILLS, MI, 48303, US

(73) Assignee: Huawei Technologies Co., Ltd.

(21) Appl. No.: 12/167,803

(22) Filed: Jul. 3, 2008

Related U.S. Application Data
(63) Continuation of application No. PCT/CN2007/001441, filed on Apr. 28, 2007.

(30) Foreign Application Priority Data
Apr. 28, 2006 (CN) 200610080001.7
Oct. 20, 2006 (CN) 200610137103.8

(51) Int. Cl. G06Q 10/00; G06Q 30/00

(52) U.S. Cl. 705/34

(57) ABSTRACT

A method, a system and an apparatus for accounting in a network. The method includes: receiving accounting information; acquiring information of an access network; generating a bill containing the information of the access network according to the accounting information and the information of the access network; and the bill being used for performing charge settlement with an access network provider of the access network.

### CROSS-REFERENCE TO RELATED APPLICATIONS

This application is a continuation of International Application No. PCT/CN2007/001441, filed Apr. 28, 2007. This application claims the benefit of Chinese Application No. 200610080001.7, filed Apr. 28, 2006, and Chinese Application No. 200610137103.8, filed Oct. 20, 2006. The disclosures of the above applications are incorporated herein by reference.

### FIELD

The present disclosure relates to IP networks, communication networks and Worldwide Interoperability for Microwave Access (WiMAX) networks and to a method, a system and an apparatus for accounting in the networks by using the information of a Network Access Provider (NAP).

### BACKGROUND

The statements in this section merely provide background information related to the present disclosure and may not constitute prior art.

FIG. 1 shows the structure of a conventional WiMAX network, and FIG. 2 shows the structure of the Access Service Network (ASN) in FIG. 1. As shown in FIG. 1 and FIG. 2, Mobile Subscriber Station (MSS) refers to a mobile subscriber equipment, and a user may access the WiMAX network via the mobile subscriber equipment. Connectivity Service Network (CSN) refers to a connectivity service network. The ASN provides wireless access services for WiMAX terminals, and the network elements of the ASN include Base Station (BS) and ASN Gateway (ASN-GW). The ASN mainly provides the following functions.

The BS is mainly configured to provide air interface access. And the BS is the access apparatus of the network (Similar to a BS in telecommunication networks).

The ASN-GW is mainly configured to converge data from BSs and connect to a core network. And the ASN-GW is an apparatus which belongs to a network convergence control layer.

FIG. 3 shows the structure of an accounting system in a conventional network.

In the conventional network, a user logs on, accesses and logs out the network in a certain access accounting mode according to requirements of the network, and an accounting client, which may refer to a Prepaid Client (PPC) in an On-line accounting procedure, automatically initiates an accounting packet according to information about the user accessing the network, and then an accounting server, which may refer to a Prepaid Agent (PPA) in an On-line accounting procedure, generates a bill corresponding to the user according to the accounting packet after receiving the accounting packet. In this way, the accounting procedure is transparent to the user, which automatically starts when the user is online and automatically ends when the user is offline. In the accounting procedure, the accounting client generates the accounting packet according to Usage Data Records (UDRs), and the UDRs are generated according to raw accounting data collected by the accounting client.

Generally, the accounting client is an access server, such as a Network Access Server (NAS) or a Broadband Access Server (BAS), and the accounting client may also be a simplified Remote Access Server (RAS), such as a Local Area Network Switch (LAN Switch), an Access Point (AP), an ASN-GW and a Cable Modem Termination System (CMTS) etc. The accounting server usually is an Authorization, Authentication and Accounting Server (AAA Server), and the accounting server may use the Remote Authentication Dial In User Service (RADIUS) protocol or other protocols typically including internal protocols, the Terminal Access Controller Access Control System (TACACS) protocol and the Diameter protocol etc.

The RADIUS protocol is a disclosed standard protocol and thus different from other private protocols. When the RADIUS protocol is used, all vendors may easily communicate with each other. Therefore, the RADIUS protocol currently is a disclosed factual standard and may be used for interworking by any vendors at any locations.

The Client/Server structure is adopted by the RADIUS protocol, and the User Datagram Protocol (UDP) is adopted for data transport. A client terminal of the RADIUS usually runs on an access server, and the client terminal is configured to send user information to a specified server and perform operations according to the response from the server. A server of the RADIUS usually runs on a work station, and the server is configured to receive a request from the client terminal, authenticate the authority of the user, and return configuration information to the client terminal, the configuration information being needed when the client terminal provides services to the user. The server of the RADIUS is also configured to receive accounting information from the client terminal and store the accounting information in a database.

Detailed description of the RADIUS protocol is available in the RFC2865, RFC2866 or RFC2869.

FIG. 4 shows protocol stacks of the entities shown in FIG. 3, and FIG. 5 shows a typical flowchart of accounting. Detailed descriptions of an accounting procedure are given as follows with references to FIGS. 3, 4, and 5.

A user successfully logs on a network.

An accounting client automatically sends an Accounting-Request (Start) packet to an accounting server. The Accounting-Request (Start) packet may refer to an Access-Request packet including a prepaid accounting capability (PPAC) in an On-line accounting procedure.

After receiving the Accounting-Request (Start) packet, the accounting server acquires information carried in the Accounting-Request (Start) packet, such as user information, accounting session information, a user address, starting time and current data traffic etc., and then the accounting server stores the information in a database as the user's accounting record, and notifies the accounting client of starting the accounting.

If a real-time protection of accounting information is needed according to network conditions and operation requirements etc., an Accounting Request (Interim) packet, which may refer to an Access-Request packet including a prepaid accounting quota (PPAQ) in an On-line accounting procedure, may be provided during the accounting procedure. In this way, the accounting client sends an Accounting Request (Interim) packet according to a predefined intermediate period.

After receiving the Accounting Request (Interim) packet, the accounting server acquires information carried in the Accounting Request (Interim) packet, such as user information, accounting session information, a user address, duration of using the network and used data traffic etc., and then the accounting server stores the information in a database as the user's accounting record, and notifies the accounting client of continuing the intermediately accounting.

The user logs out the network when finishing using the network. The user may initiate disconnecting, or the system may force the user to be offline if detect an anomaly and etc.

The accounting client automatically sends an Accounting-Request (Stop) packet, which may refer to an Access-Request packet including a PPAQ in an On-line accounting procedure, to the accounting server.

After receiving the Accounting-Request (Stop) packet, the accounting server acquires information carried in the Accounting-Request (Stop) packet, such as user information, accounting session information, a user address, duration of using the network and used data traffic etc., and then the accounting server stores the information in a database as the user's accounting record, and notifies the accounting client of stopping the accounting.

In practical applications, whether the accounting is performed, whether the intermediate accounting is performed, whether the accounting is performed according to the duration, the traffic, and the network location are all strategies. Generally, the strategies may be configured according to network conditions and user's operating requirements.

The accounting information of the user is all stored in the accounting server, and a billing system may directly acquire needed accounting information and convert the raw accounting information to a real bill of the user according to charge rate and a calculation mode which are configured according to operation requirements.

It is to be noted that, in the latest standards of the WiMAX, both usage-based accounting and flow-based accounting are supported. FIG. 6 shows the flowchart of flow-based accounting. As shown in FIG. 6, Accounting client starts the accounting when service flow is successfully established instead of when a user successfully logs on a network. In FIG. 6, Accounting client may be an AAA client, Visited Accounting Server may be a Visited AAA Server, and Home Accounting Server may be a Home MA Server. The process shown in FIG. 6 is similar to that shown in FIG. 5, and the difference is that the accounting is triggered at different times. In the process shown in FIG. 5, the accounting is triggered when the user successfully logs on the network, which is an example of usage-based accounting, and in the process shown in FIG. 6, the accounting is triggered when the service flow is successfully established, which is an example of flow-based accounting.

In addition, according to the latest WiMAX standard, the information of the access network carried in the accounting packet includes: a Network Access Server Identity (NAS-ID) which is the information identifying the NAS, a Home Agent IP address (Home Agent-IP) which is the IP address of a Home Agent in either an IPv4 or IPv6 network, a Network Access Server IP address (NAS-IP-Address) which is the IP address of an network access server. An accounting packet at least includes the NAS-ID or the NAS-IP-Address.

As can be seen that, according to the latest WiMAX standard, the information related to the access network in the accounting packet only includes such as the NAS-ID, the NAS-IP-Address, the Home Agent-IP, and the information of a network access provider is not included. Therefore, after receiving an accounting packet, a Network Service Provider (NSP) of the user can not determine, according to the accounting packet, how to perform charge settlement between the NSP and the network access provider which provides the network access for the user.

In other words, after the accounting server of the NSP receives the accounting packet, the accounting server needs to perform charge settlement with the network access provider according to information carried in the accounting packet. If the information of the network access provider is not carried in the accounting packet, the accounting server of the NSP is unable to determine the network access provider corresponding to the accounting packet, and thus charge settlement is unable to be performed between the NSP and the network access provider.

### SUMMARY

The embodiments provide a method, a system and an apparatus for accounting in a network, so as to charge according to the information of an access network.

The embodiments include the following.

A method for accounting in a network includes:

receiving accounting information;

acquiring information of an access network;

generating a bill containing the information of the access network according to the accounting information and the information of the access network; and the bill being used for performing charge settlement with an access network provider of the access network.

A system for accounting in a network includes:

an accounting client, adapted to transmit accounting information; and

an accounting server, adapted to acquire information of an access network, and generate a bill containing the information of the access network according to the accounting information received from the accounting client and the information of the access network, the bill being used for performing charge settlement with an access network provider of the access network.

An accounting server includes:

an accounting receiver unit, adapted to receive accounting information; and

an bill generator unit, adapted to generating a bill according to the accounting information and information of an access network, the bill being used for performing charge settlement with an access network provider of the access network.

In the embodiments, the information of an access network is carried by an accounting message or an authentication message or added in a static configuration table, and charge settlement may be performed according to the information of the access network. Therefore, a more detailed bill may be provided in a WiMAX network, an IP network and a communication network. Furthermore, charge settlement may be performed between an accounting server of a NSP and the provider of the access network according to the accounting information contained in the accounting message and the information of the access network contained in the accounting message or the authentication message or the static configuration table.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a schematic diagram illustrating a structure of a conventional WiMAX network.

FIG. 2 is a schematic diagram illustrating a structure of the ASN in FIG. 1.

FIG. 3 is a schematic diagram illustrating a structure of an accounting system in a conventional network.

FIG. 4 is a schematic diagram illustrating protocol stacks of the network entities in FIG. 3.

FIG. 5 is a flowchart illustrating a conventional method for accounting in a network.

FIG. 6 is a flowchart illustrating a conventional method for accounting in a WiMAX network.

FIG. 7 is a flowchart illustrating a method for accounting in a network in accordance with a first embodiment .

FIG. 8 is a flowchart illustrating a method for accounting in a network in accordance with a second embodiment .

FIG. 9 is another flowchart illustrating a method for accounting in a network in accordance with the second embodiment .

FIG. 10 is a flowchart illustrating a method for accounting in a network in accordance with a third embodiment .

FIG. 11 is another flowchart illustrating a method for accounting in a network in accordance with the third embodiment .

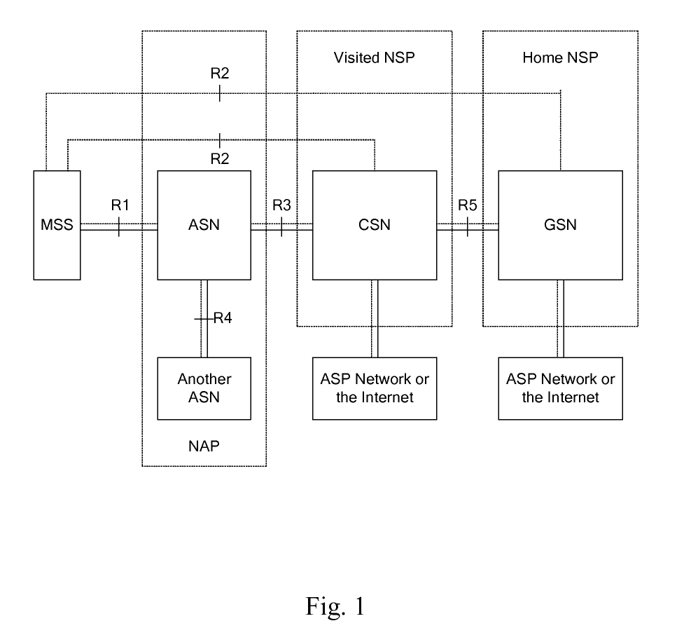

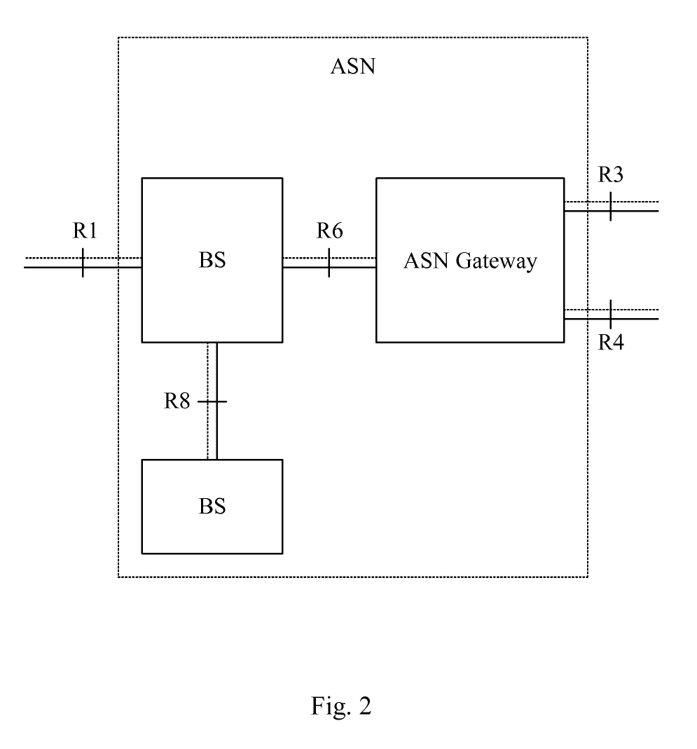

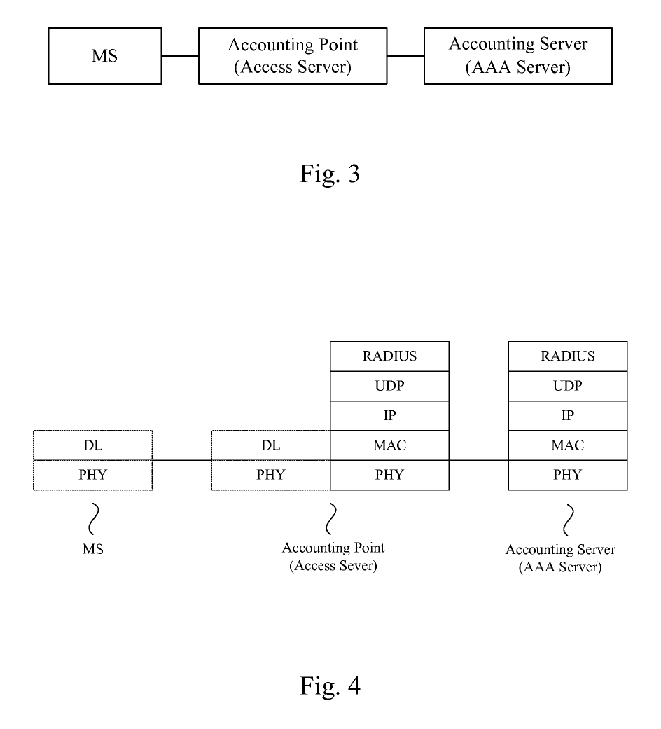

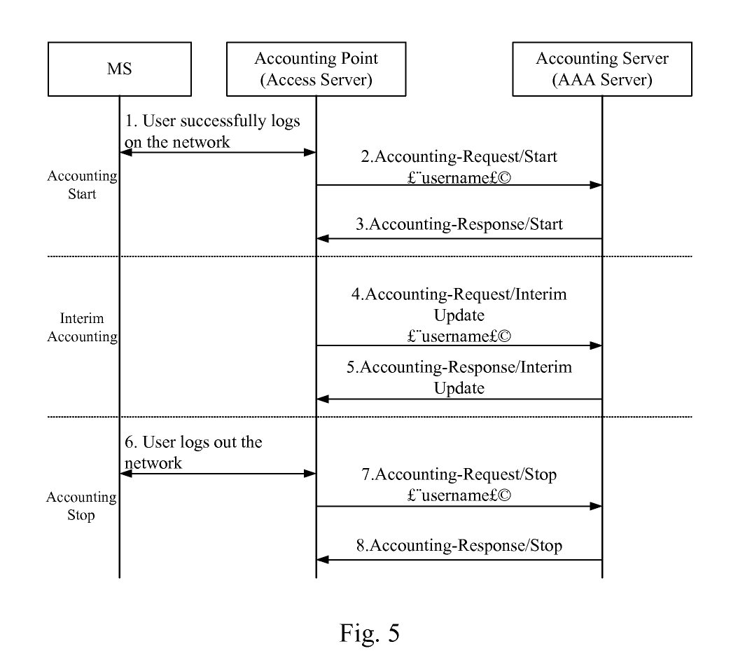

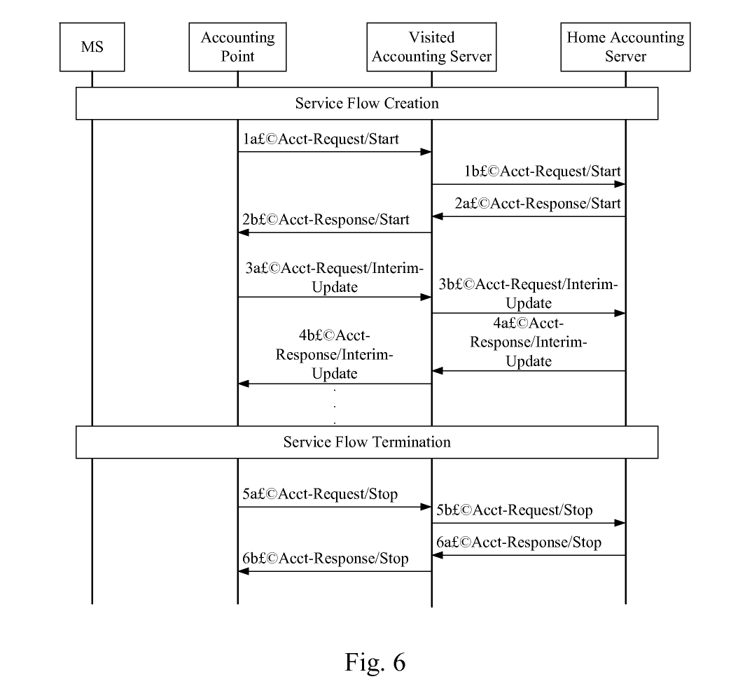

### DETAILED DESCRIPTION

The following description is merely exemplary in nature and is not intended to limit the present disclosure, application, or uses.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

In the embodiments , a usage data record, an accounting packet, an authentication message or the content stored in an accounting server is modified in existing networks such as an IP network, a communication network or a WiMAX network. The modification includes that the information of an access network is added in the usage data record or the accounting packet or the authentication message, or a static configuration table containing the information of the access network is added in the content stored in the accounting server. Therefore, a bill generated by a NSP according to the accounting information carried in the accounting message and the information of the access network may contain the information of the access network, and charge settlement may be performed between the NSP and the provider of the access network according to the information of the access network.

The information of the access network includes: the identifier of an access network operator, the identifier of an access network or the information of a network access provider.

Various embodiments will now be described in more detail with reference to the drawings.

In an embodiment, the information of a network access provider is carried by an accounting message.

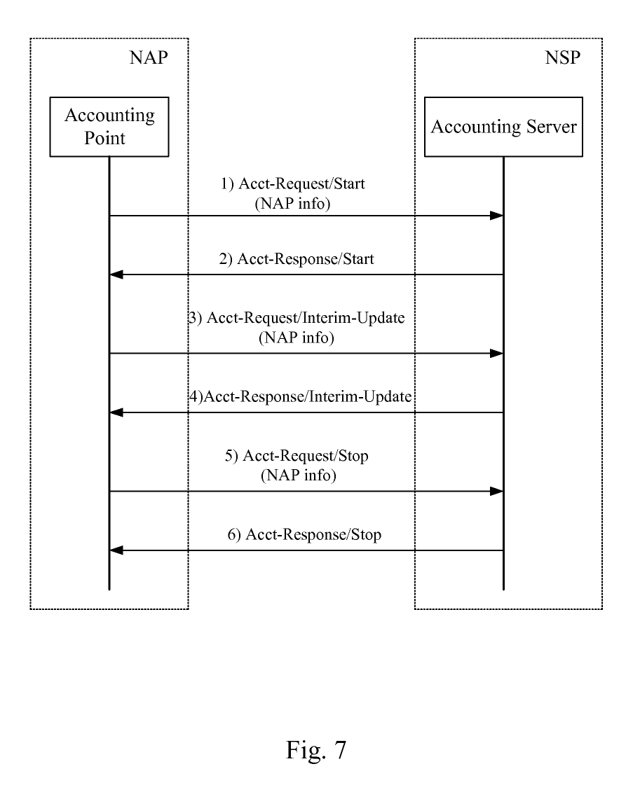

As illustrated in FIG. 7, an accounting system in the embodiment includes an accounting client and an accounting server. For example, the accounting client may refer to a Prepaid Client (PPC) in an On-line accounting procedure, and the accounting server may refer to a Prepaid Agent (PPA) in an On-line accounting procedure. The client/server structure of the RADIUS protocol is adopted in the embodiment. The accounting client may be an AAA client, that is to say, authentication, authorization and accounting are performed on the same device. And in practical application the accounting client typically is an access server, such as a NAS, a BAS, or a simplified RAS which includes an Ethernet switcher, an AP, an ASN-GW, and a CMTS etc. The accounting client is configured to send accounting message to the accounting server when a user logs on or logs out a network. The accounting server usually is an AAA server or a dedicated accounting server, and the accounting server may use the RADIUS protocol or other protocols which typically include internal protocols, the TACACS protocol and the Diameter protocol. The accounting server is configured to receive the accounting message from the accounting client and generate a bill according to the accounting message, so that charge settlement may be performed.

In the embodiment , the accounting client includes a transmitter unit, and after a user logs on the network or service flow is established, the transmitter unit of the accounting client sends an accounting message i.e., an accounting packet to the accounting server. The accounting packet is generated by the accounting client according to a UDR, and the information of the network access provider is carried in the UDR or the accounting packet. Detailed explanations about what to add and how to add are given below. The accounting server includes an accounting receiver unit and a bill generator unit. The accounting receiver unit is configured to receive information from the accounting client, and the bill generator unit is configured to generate the bill according to the received accounting packet containing the information of the network access provider, and thus the bill also contains the information of the network access provider. Therefore, charge settlement may be performed between a NSP and the network access provider according to the information of the network access provider.

In the embodiment, the accounting packet includes an accounting start packet and an accounting stop packet, so that the NSP may generate the bill according to information carried in the accounting packet which stored in the accounting server. The information includes the user information, the accounting session information, the user address, the starting time, the duration of using the network and the used data traffic etc. Further, the accounting packet may further include an intermediate accounting packet, and whether the intermediate accounting packet is used may be determined according to network conditions or operational requirements.

The information of the network access provider may be an identifier which can identify the access network operator, and the identifier may be an NAP ID, defined by the WiMAX Forum NWG standard, and is an identifier of 24 bits, related to the access network, the owner of a Base Station and the owner of spectrum. The identifier may also be an Operator ID, defined by the IEEE 802.16-2004 standard, and is an identifier of 24 bits, which is the first 24 bits of the Base Station ID of 48 bit, and used for broadcasting on air interface, such as DL-MAP. In the embodiment, the information of the network access provider may be contained in the UDR generated by the accounting client according to the raw accounting data, and then the accounting packet is generated according to the UDR, and the information of the network access provider may also be directly contained in the accounting packet to be sent.

In the embodiment, the specific way of carrying the information of the network access provider in the accounting message, i.e., the accounting packet is not limited. If the RADIUS protocol is used as the bearer protocol of accounting packet, the accounting information is the RADIUS information, and the content of the accounting packet may be carried by properties defined in the RADIUS protocol. For example, the information of network access provider may be carried by the Vendor-Specific Property of the RADIUS protocol or the NAS-Identifier property of the RADIUS protocol. In addition, the information of the network access provider may also be carried by adding a Base Station ID (BS ID) in the usage data record or the accounting packet. In the current standard, the BS ID is 48 bit, the first 24 bits may be used for identifying the network access provider, and the BS ID may be carried by the Vendor Specific property or other properties of the RADIUS protocol. If other protocol is used by the accounting packet, the content of the accounting packet may be carried by a property defined by the protocol. Therefore, the ways of carrying the information of the network access provider are not limited to the three ways, and any way by which the information of the network access provider can be carried by the usage data record or the accounting packet is within the protection scope of the present disclosure.

FIG. 7 shows the flowchart of a method in accordance with an embodiment. With reference to FIG. 7, the process of the method for accounting is as follows.

1) An accounting client sends to an accounting server an Accounting-Request (Start) packet, which may refer to an Access-Request packet including a PPAC in an On-line accounting procedure and is described as the Accounting-Request (Start) packet in the embodiments . The information of a network access provider is carried in the Accounting-Request (Start) packet, and may be contained in a UDR generated by the accounting client or directly contained in the Accounting-Request (Start) packet.

2) After receiving the Accounting-Request (Start) packet, the accounting server acquires information carried in the Accounting-Request (Start) packet, and notifies the accounting client of starting the accounting.

3) Similar to the conventional process, if a real-time protection of accounting information is needed according to network conditions and operation requirements etc., an Accounting Request (Interim) packet may be provided during the accounting procedure, and the Accounting Request (Interim) packet may refer to an Access-Request packet including a PPAQ in an On-line accounting procedure and is described as the Accounting-Request (Interim) packet in the embodiments . In this way, the accounting client sends an Accounting Request (Interim) packet according to a predefined intermediate period, and the Accounting Request (Interim) packet also includes the information of the network access provider.

4) After receiving the Accounting Request (Interim) packet, the accounting server acquires information carried in the Accounting Request (Interim) packet, and the information contains the information of the network access provider, and then the accounting server stores the information in a database as a user accounting record, and notifies the accounting client of continuing the intermediately accounting.

5) After the user logs out the network, the accounting client sends to the accounting server an Accounting-Request (Stop) packet, which may refer to an Access-Request packet including a PPAQ in an On-line accounting procedure and is described as the Accounting-Request (Stop) packet in the embodiments . The Accounting-Request (Stop) packet also contains the information of the network access provider.

6) After receiving the Accounting-Request (Stop) packet, the accounting server acquires information carried in the Accounting-Request (Stop) packet, stores the information in a database as a user accounting record, and notifies the accounting client of stopping the accounting.

Through the above process, a NSP may determine the network access provider corresponding to the accounting packet according to the information carried in the accounting packet (containing the information of the network access provider), and then charge settlement may be performed between the NSP and the network access provider.

The method of the embodiment may be implemented by the following system and apparatus.

A network accounting system includes an accounting client and an accounting server. The accounting client includes an accounting information transmitter unit and a network access provider information transmitter unit, and the accounting information transmitter unit is configured to send accounting information to the accounting server according to information about the user accessing the network, and the network access provider information transmitter unit is configured to send the information of a network access provider to the accounting server. The accounting server includes an accounting receiver unit and a bill generator unit, and the accounting receiver unit is configured to receive the accounting information and the information of the network access provider which are sent by the accounting client, and the bill generator unit is configured to generate a bill containing the information of the network access provider according to the received accounting information and the information of the network access provider, so that charge settlement may be performed between a NSP and the network access provider.

Since the method of the embodiment is described in detail, the combination of the method and system is not further described.

In various embodiments, the information of a network access provider is added in an authentication message.

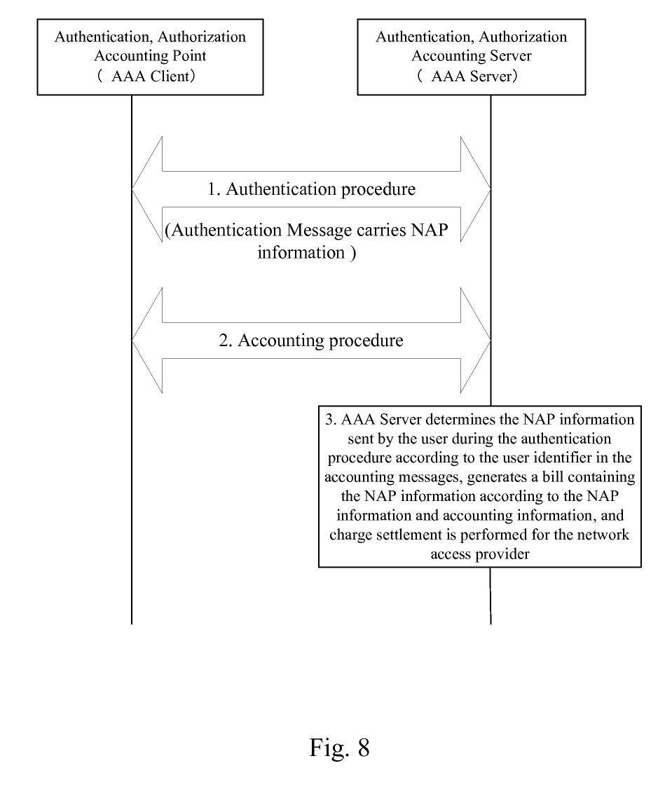

FIG. 8 shows a flowchart of a method for accounting in a network in accordance with a second embodiment . Different from the first embodiment in which the information of the network access provider is carried by an accounting message, in the embodiment as shown in FIG. 8, the information of the network access provider is carried in an authentication message and transmitted to an authentication server by an authentication point during an authentication procedure, and then an accounting procedure starts; an accounting server, according to the user identifier carried in an accounting message, determines the information of the network access provider which is sent by the user during the authentication procedure, and then the accounting server generates a bill containing the information of the network access provider according to the information of the network access provider and the accounting message, and then charge settlement may be performed between a NSP and the network access provider.

In the embodiment, an authentication point, an authorization point and an accounting client are implemented by the same device. In practical, the three points may also be separate which is similar to the case that the authentication server, the authorization server and the accounting server are separate. If the three points are separate, the authentication point sends an authentication message to an authentication server in the authentication procedure, and the accounting client sends an accounting message to an accounting server in the accounting procedure. In most cases, the accounting client and the authentication point are implemented by the same device, and the accounting server and the authentication server are implemented by the same device. If the authentication point and the authentication server are independent, the accounting server needs to communicate with the authentication server after receiving the accounting message so as to acquire the information of the network access provider.

It is to be noted that, the accounting client, the accounting server, the content of the information of the network access provider and the way of carrying the information of the network access provider are similar with those in the various embodiments. Therefore, no further description is given.

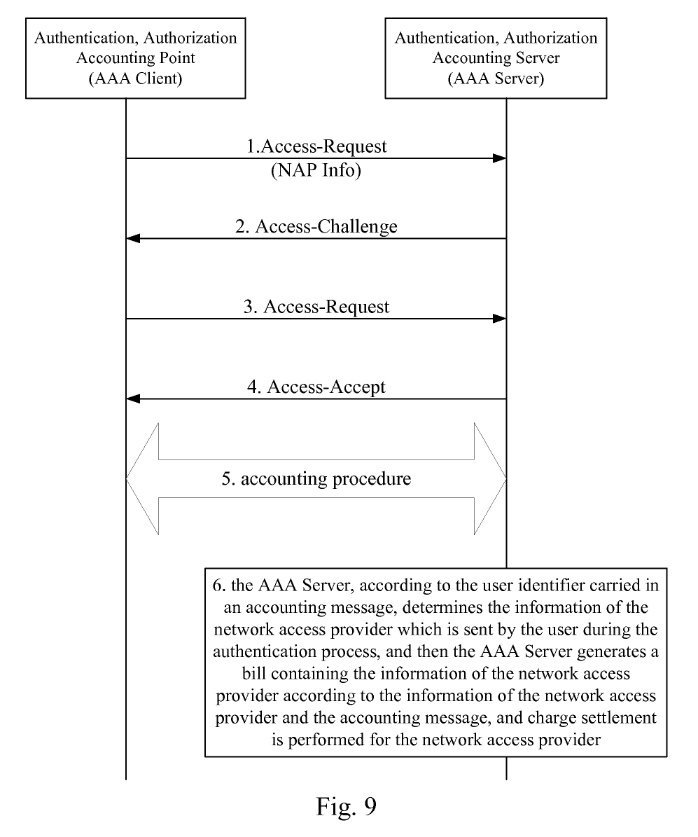

FIG. 9 shows a flowchart of the method for accounting in a network in accordance with various embodiments . In the embodiment, the authentication point, the authorization point and the accounting client are implemented by an Authentication Authorization Accounting client, the authentication server, the authorization server and the accounting server are implemented by an Authentication, Authorization and Accounting server (AAA Server), and the information of the network access provider is carried by an authentication message sent firstly (item 1 in FIG. 9). Obviously, the above descriptions are non-limiting, the types of the accounting client and the accounting server may be the same as those described in the various embodiments, and the information of the network access provider may also be carried by an authentication message sent secondly (item 3 in FIG. 9). As shown in FIG. 9, the embodiment includes the following.

1. The Authentication Authorization Accounting client, which may be the AAA Client or the NAS, sends an authentication message, i.e., an Access-Request message, to the AAA Server, and the information of the network access provider is carried by the Access-Request message.

2. The AAA Server sends an Access-Challenge message to the Authentication Authorization Accounting client.

3. The Authentication Authorization Accounting client sends the Access-Request message to the AAA Server, and then the AAA Server performs an authentication.

4The AAA Server determines whether a user is valid according to the user information, and then sends a message, i.e., an Authentication Success message or an Authentication Failure message to the Authentication Authorization Accounting client. If the authentication is successful, the AAA Server sends the Authentication Authorization Accounting client the message carrying negotiation parameters and service properties of the user to indicate that the user is authorized.

5. A normal accounting procedure which is similar with the procedure described in the conventional standard is started.

6. The AAA Server, according to the user identifier carried in an accounting message, determines the information of the network access provider which is sent by the user during the authentication procedure, and then the AAA Server generates a bill containing the information of the network access provider according to the information of the network access provider and the accounting message, and a charge settlement may be performed with the network access provider.

In the embodiment, the authentication procedure is similar to the conventional authentication procedure, and is not further described. Different from the conventional procedure, the authentication message in the embodiment contains the information of the network access provider, so that the accounting server may generate the bill containing the information of the network access provider according to the accounting information in the accounting procedure and the information of the network access provider. Therefore, charge settlement is performed between an NSP and the network access provider according to the bill.

The method of the embodiment may be implemented by the following system and apparatus.

A network accounting system includes an accounting client, an authentication point, an accounting server and an authentication sever. The accounting client includes an accounting information transmitter unit which is configured to send accounting information to the accounting server according to information about a user accessing the network. The authentication point includes an authentication message transmitter unit and a network access provider information transmitter unit. The authentication message transmitter unit is configured to send an authentication message to the authentication server according to the information about the user accessing the network, and the network access provider information transmitter unit is configured to send the information of a network access provider to the authentication server. The accounting server includes an accounting receiver unit and a bill generator unit. The accounting receiver unit is configured to receive the information sent by the accounting client, and the bill generator unit is configured to generate a bill containing the information of the network access provider according to the received accounting information and the information of the network access provider, so that charge settlement may be performed between a NSP and the network access provider according to the bill. The authentication server includes an authentication receiver unit and an information exchange unit. The authentication receiver unit is configured to receive information sent by the authentication point, and the information exchange unit is configured to exchange the information of the network access provider with the accounting server.

Since the method of the embodiment is described in detail, the combination of the method and the system is not further described.

Obviously, the authentication point and the accounting client may work separately or together. Similarly, the authentication server and the accounting server may work separately or together.

In the embodiment, a static configuration table containing the information of a network access provider is added in the content stored by an accounting server.

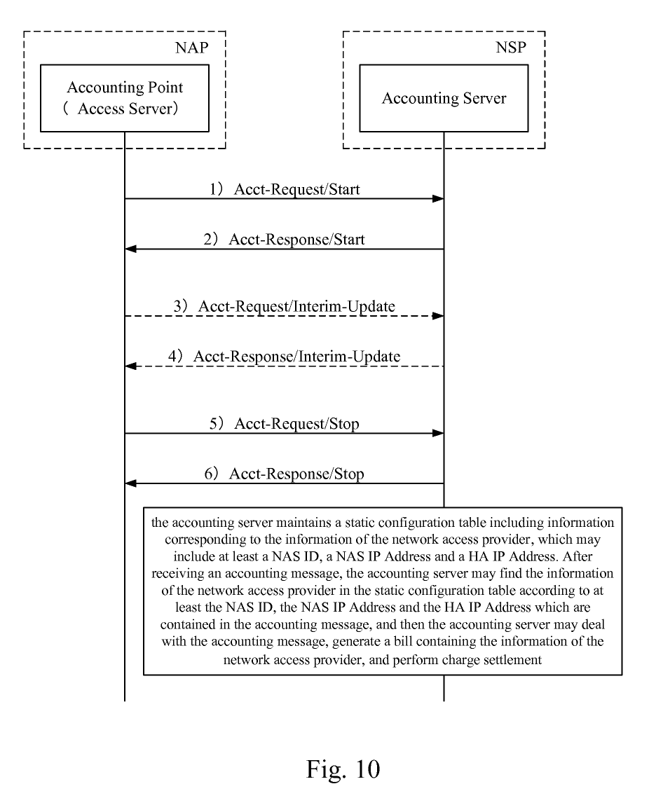

FIG. 10 shows a flowchart of a method for accounting in a network in accordance with various embodiments . Different from the other various embodiments, the conventional authentication and accounting procedure are not modified in the embodiment, i.e., the information of the network access provider is neither added in an accounting message nor carried in an authentication message. Instead, a static configuration table is added and maintained in the content stored by an accounting server. Besides the information of the network assess provider, the static configuration table also includes information corresponding to the information of the network access provider, which may include at least one of a Network Access Server Identifier (NAS ID), a Network Access Server IP Address (NAS IP Address) and a Home Agent IP Address (HA IP Address). Therefore, after receiving an accounting message, the accounting server may find the information of the network access provider in the static configuration table according to at least the NAS ID, the NAS IP Address and the HA IP Address which are contained in the accounting message, and then the accounting server may deal with the accounting message, generate a bill containing the information of the network access provider, and perform charge settlement.

The accounting client, the accounting server and the content of the information of the network access provider are the same as those in the various embodiments, and are not further described.

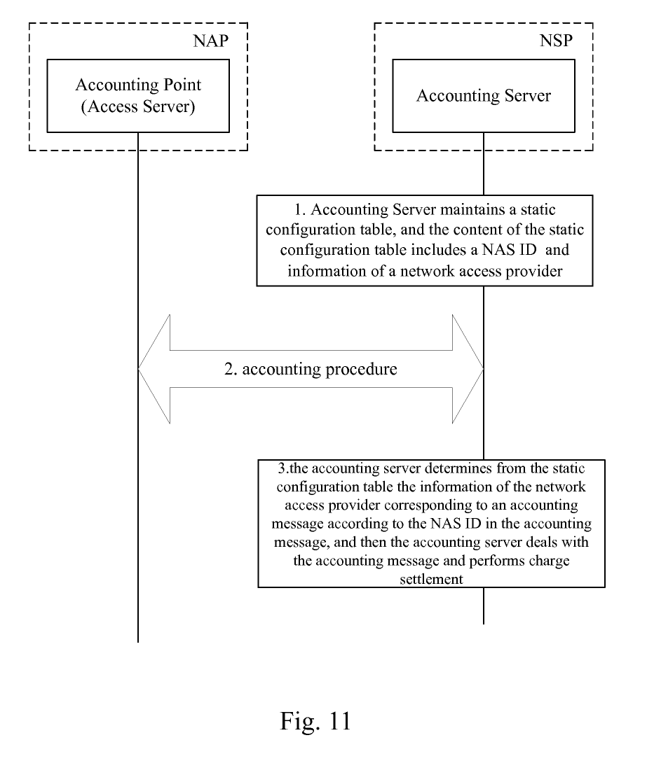

FIG. 11 shows a flowchart of the method for accounting in a network in accordance with the various embodiments . In the embodiment, the static configuration table contains a NAS ID and the information of a network access provider. Obviously, the above descriptions are not intended to be limiting. In practical, the static configuration table may contain other information, such as a NAS IP address and the information of a network access provider, or other information combined with the information of the network access provider. The accounting client and the accounting server in the various embodiments are similar with those in the first embodiment. As shown in FIG. 11, the embodiment includes the following.

1. An accounting server locally maintains a static configuration table, and the content of the static configuration table includes a NAS ID and the information of a network access provider.

2. A normal accounting procedure of a user is performed.

3. The accounting server determines from the static configuration table the information of the network access provider corresponding to an accounting message according to the NAS ID in the accounting message, and then the accounting server deals with the accounting message and performs charge settlement.

In the embodiment, the static configuration table containing the information of the network access provider is configured in the content stored by the accounting server, and the static configuration table contains the information corresponding to the information of the network access provider, such as the NAS ID, the NAS IP Address and the HA IP Address etc. Therefore, after receiving the accounting message, the accounting server may determine the information of the network access provider in the static configuration table according to the information carried in the accounting message, and generate a bill containing the information of the network access provider, so that charge settlement is performed between an NSP and the network access provider.

The method of the embodiment may be implemented by the following system and apparatus.

A network accounting system includes an accounting client and an accounting server. The accounting client includes an accounting information transmitter unit which is configured to send accounting information to the accounting server according to information about the user accessing the network. The accounting server includes an accounting receiver unit, a bill generator unit and a network access provider information configuration unit. The accounting receiver unit is configured to receive information from the accounting client; the bill generator unit is configured to generate a bill containing information of a network access provider according to the received accounting information and the information of the network access provider, so that charge settlement may be performed between a NSP and the network access provider according to the bill; the network access provider information configuration unit is configured to store the information of the network access provider and information corresponding to the information of the network access provider which includes at least one of a NAS ID, a NAS IP Address and a HA IP Address etc, so that the accounting server may determines the information of the network access provider in the network access provider information configuration unit according to the information contained in the accounting information which includes at least the NAS ID, the NAS IP Address and the HA IP Address etc., and then the bill containing the information of the network access provider is generated.

The packet described in the various embodiments may refer to one type of message or a set of multiple types of messages. For example, the accounting start packet may refer to both an Accounting-Request (Start) packet and an Accounting-Response (Start) packet.

Since the method of the embodiment is described in detail, the combination of the method and the system is not further described.

The embodiments are not only applicable to WiMAX networks, but also applicable to broadband IP networks. The methods, systems and apparatuses may be used in the above networks, as so to perform charge settlement conveniently. Regardless of the way of accounting which may include accounting according to user connections or accounting according to service flow or any other ways, the information of the network access provider may always be carried by an accounting message or an authentication message, or a static configuration table containing the information of the network assess provider may always be configured in the accounting server, so that charge settlement may be performed between a NSP and the network access provider according to the information of the network access provider contained in a generated bill.

The above are only preferred embodiments and are not for use in limiting the protection scope of the present disclosure. All modifications, equivalent replacements or improvements made within the principles of the present disclosure should be covered under the protection scope of the present disclosure.

What is claimed is:

1. A method for accounting in a network, comprising:
receiving accounting information;
acquiring information of an access network;
generating a bill containing the information of the access network according to the accounting information and the information of the access network; and the bill being used for performing charge settlement with an access network provider of the access network.

2. The method of claim 1, wherein the acquiring the information of the access network comprises:
acquiring the information of the access network from an accounting message containing the information of the access network.

3. The method of claim 2, wherein the information of the access network is carried in the accounting message; or
the information of the access network is carried in a Usage Data Record (UDR) contained in the accounting message.

4. The method of claim 3, wherein when the information of the access network is carried in the accounting message, at least one of the information of the access network in the accounting message is carried by a property defined in Remote Authentication Dial In User Service (RADIUS) protocol or is carried by a Base Station Identity; or
when the information of the access network is carried in the UDR, the information of the access network is carried by a Base Station Identity in the UDR.

5. The method of claim 1, wherein the acquiring the information of the access network comprises:
acquiring the information of the access network from an authentication server, the information of the access network being contained in an authentication message received by the authentication server.

6. The method of claim 5, wherein the information of the access network in the authentication message is carried by a property defined in RADIUS protocol or is carried by a Base Station Identity.

7. The method of claim 5, wherein the acquiring the information of the access network from the authentication server comprises:
acquiring the information of the access network according to a user identity in an accounting message.

8. The method of claim 1, wherein the acquiring the information of the access network comprises:
receiving an accounting message, the accounting message comprising at least one of a Network Access Server identifier, a Network Access Server IP address and a Home Agent IP address; and
determining the information of the access network according to at least one of the Network Access Server identifier, the Network Access Server IP address and the Home Agent IP address.

9. A system for accounting in a network, comprising:
an accounting client, adapted to transmit accounting information; and
an accounting server, adapted to acquire information of an access network, and generate a bill containing the information of the access network according to the accounting information received from the accounting client and the information of the access network, the bill being used for performing charge settlement with an access network provider of the access network.

10. The system of claim 9, wherein the accounting client is further adapted to transmit the information of the access network.

11. The system of claim 9, further comprising:
an authentication point, adapted to transmit the information of the access network;
an authentication server, adapted to receiving the information of the access network, and transmit the information of the access network to the accounting server.

12. The system of claim 9, wherein the accounting server is further adapted to receive at least one of a Network Access Server identifier, a Network Access Server IP address and a Home Agent IP address, and acquire the information of the access network according to at least one of the Network Access Server identifier, the Network Access Server IP address and the Home Agent IP address.

13. The system of claim 12, wherein the accounting client is further adapted to transmit at least one of the Network Access Server identifier, the Network Access Server IP address and the Home Agent IP address.

14. The system of claim 11, wherein the system is an IP network or a communication network or a WiMAX network.

15. An accounting server, comprising:
an accounting receiver unit, adapted to receive accounting information; and
an bill generator unit, adapted to generating a bill according to the accounting information and information of an access network, the bill being used for performing charge settlement with an access network provider of the access network.

16. The accounting server of claim 15, wherein the accounting receiver unit is further adapted to receive the information of the access network transmitted by an accounting client.

17. The accounting server of claim 15, wherein the accounting receiver unit is further adapted to receive the information of the access network transmitted by an authentication server.

18. The accounting server of claim 15, further comprising:
an access network information configuration unit, adapted to receive at least one of a Network Access Server identifier, a Network Access Server IP address and a Home Agent IP address, and determine the information of the access network according to at least one of the Network Access Server identifier, the Network Access Server IP address and the Home Agent IP address.
